(19) United States
(12) Patent Application Publication
(10) Pub. No.: US 2013/0068068 A1
(43) Pub. Date: Mar. 21, 2013

(54) Modulated shifting transmission with parallel power paths.

(71) Applicant: Holger Witt, Buehl-Weitenung (DE)

(72) Inventor: Holger Witt, Buehl-Weitenung (DE)

(21) Appl. No.: 13/621,861

(22) Filed: Sep. 18, 2012

(30) Foreign Application Priority Data
Sep. 19, 2011 (DE) 10 2011 082 966.0
Oct. 26, 2011 (DE) 10 2011 085 202.6

(51) Int. Cl. F16H 37/06; F16H 3/08

(52) U.S. Cl. 74/661; 74/331; 475/151

(57) ABSTRACT

A transmission (20) with three or more parallel power paths (21, 22, 23) transferring torque from the input shaft (40) to the output shaft (60). Each of said power paths consists of a summation gearbox (100, 200, 300), an electric machine (400, 500, 600) and a sub transmission (700, 800, 900). Each of said sub transmissions has one or more independently selectable gear ratios. The outputs (702, 802, 902) of said sub transmissions drive together said output shaft. Controlling toque and speed of said electric machines allows controlling torque and speed at the inputs (701, 801, 901) of said sub transmissions and allows said power paths to have different total gear ratios from said input shaft to said output shaft engaged at the same time. With this arrangement an infinitely variable transmission with hybrid functionalities and a very compact mechanical design and reduced weight can be implemented.

### CROSS-REFERENCE TO RELATED APPLICATIONS

This application claims the benefit of foreign application priorities of DE10 2011 082 966.0 filed on the 19 of Sep. 2011 and DE 10 2011 085 202.6 filed on the 26 of Oct. 2011 filed at the German patent office.

These applications have been filed by the inventor's employer, who transferred the priority rights for filing at the U.S. Patent and Trademark Office to the inventor.

### STATEMENT REGARDING FEDERALLY-SPONSORED RESEARCH OR DEVELOPMENT

Not applicable.

### REFERENCE TO SEQUENCE LISTING, TABLE OR COMPUTER PROGRAM LISTING

Not applicable.

### BACKGROUND OF THE INVENTION—PRIOR ART

The following is a tabulation of some prior art that presently appears relevant.

U.S. Patents:

| Pat. No. | Kind Code | Issue Date | Patentee |
|---|---|---|---|
| 6,558,283 | B1 | May 6, 2003 | Schnelle |

Non-Patent Literature Documents:

Harald Naunheimer, Bernd Bertsche, Joachim Ryborz, Wolfgang Novak, Automotive Transmissions—Fundamentals, Selection, Design and Application, ISBN 978-3-642-16213-8

In U.S. Pat. No. 6,558,283 a transmission for motor vehicles with two planetary gears, two electric machines and two counter shafts with several engage able gear ratios is proposed. This transmission allows an infinitely variable gear ratio, starting an internal combustion engine, generating on board power and several hybrid functions as described in U.S. Pat. No. 6,558,283.

In “Automotive Transmissions—Fundamentals, Selection, Design and Application”, there are examples of transmissions for commercial vehicles having the output shaft of the main transmission being coupled to the input shaft of a range gear box. With this range gearbox the number of different speeds of the main transmission gets multiplied by the number of different speeds of the range gearbox in such manner, that for example the 1^{st} speed of a 4 speed main transmission becomes the 5^{th} speed after shifting the range gearbox to the next higher speed.

In “Automotive Transmissions—Fundamentals, Selection, Design and Application” chapter “12.2 Commercial Vehicle Transmissions” a transmission for high torque applications like for heavy load trucks is described using the example of the Eaton Twin Splitter transmission. In this transmission the input power of the internal combustion engine is equally split into two parallel power paths. Both power paths work in parallel driving the output shaft and always have the same gearing transmission ratio. This allows designing the individual gearwheels with smaller dimensions and by that to reduce to total length of the transmission.

### BRIEF SUMMARY OF THE INVENTION—ADVANTAGES

Several advantages of the here proposed transmission with one or more aspects of the different embodiments are as follows: by having three or more parallel power paths, each of the parallel power paths can be designed for transmitting only a part of the total transmission torque allowing to reduce size and weight of the transmission and/or to design the transmission for higher maximum torque.

Other advantages of one or more aspects will be apparent from a consideration of the drawings and ensuing description.

### DRAWINGS—FIGURES

Closely related elements have in the different figures the same number but a different alphabetic suffix.

FIG. 1 gives a schematic overview for an embodiment with 3 parallel power paths, their main components and their interactions.

FIGS. 2A and 2B show schematically an embodiment with 3 parallel power paths having 6 forward speeds and 3 reverse speeds. FIG. 2A shows 2 of the 3parallel power paths referred in the text as being power paths A and C. FIG. 2B shows the 3^{rd} power path referred in the text as being power path B.

FIG. 3 shows schematically the relative positions of input shaft, output shaft, countershafts, planetary gearboxes and a central gearwheel driving the ring gears of the planet gearboxes. Viewed from the input side of the transmission.

FIG. 4A and 4B show schematically an embodiment with 3 parallel power paths and two range gearboxes resulting in a transmission with 12 forward speeds and 3 reverse speeds. FIG. 2A shows 2 of the 3 parallel power paths referred in the text as power paths A and C. FIG. 2B shows the 3^{rd} parallel power path referred in the text as power path B.

FIG. 5 shows schematically an embodiment with two modulated parallel power paths with an additional electric machine coupled to the main motor.

FIG. 6 shows schematically an embodiment using a dedicated modulated shifting transmission for each driven wheel.

FIG. 7 shows schematically an embodiment with an internal combustion engine having the crankshaft exiting the motor on both sides and each end of the crankshaft being coupled to an independent modulated shifting transmission.

FIG. 8 shows schematically the main electric connections for an embodiment using externally excited direct current machines.

### DRAWINGS—REFERENCE NUMERALS

Reference numerals in the ranges 100 until 199 and 400 until 499 and 700 until 799 refer to elements being part of a power path A.

Reference numerals in the ranges 200 until 299 and 500 until 599 and 800 until 899 refer to elements being part of a power path B.

Reference numerals in the ranges 300 until 399 and 600 until 699 and 900 until 999 refer to elements being part of a power path C.

The used reference numerals are listed below:

| | | | |
|---|---|---|---|
| 20 | Transmission | 21 | Power path A |
| 22 | Power path B | 23 | Power path C |
| 40 | Input shaft | 41 | Gearwheel on the input shaft |
| 42 | Input shaft brake | 43 | Additional electric machine |
| 44 | Friction clutch | 45 | Main motor |
| 46 | Battery | 47 | Electric power exchange unit |
| 60 | Output shaft | 61 | Output gearwheel for 1^{st}, 2^{nd} and 3^{rd} |
| | | | speed |
| 62 | Output gearwheel for 4^{th}, 5^{th} and 6^{th} | 63 | Output gearwheel for 1^{st}, 2^{nd} and 3^{rd} |
| | speed | | reversed speed |
| 64 | Output shaft brake | | |
| 70 | Range gearbox | 71 | Sun gear |
| 72 | Set of planet gearwheels | 73 | Carrier |
| 74 | Ringgear | 75 | Unit to selectively couple the ring |
| | | | gear with the sun gear or with the |
| | | | transmission housing. |
| 76 | Coupling to the transmission housing | | |
| 80 | Range gearbox | 81 | Sun gear |
| 82 | Set of planet gearwheels | 83 | Carrier |
| 84 | Ringgear | 85 | Unit to selectively couple the ring |
| | | | gear with the sun gear or with the |
| | | | transmission housing. |
| 86 | Coupling to the transmission housing | | |
| 90 | Bevel gearbox | | |
| 92 | Left side modulated shifting | 93 | Right side modulated shifting |
| | transmission | | transmission |
| 94 | Left side drive wheel | 95 | Right side drive wheel |
| 96 | Input shaft | 97 | Input shaft |
| 98 | Output shaft | 99 | Output shaft |
| 100 | Summation gearbox | 101 | 1^{st} input of the summation gearbox |
| 102 | 2^{nd} input of the summation gearbox | 103 | 3^{rd} input of the summation gearbox |
| 110 | Planetary gearing | | |
| 112 | Ring gear | 114 | Set of planet gearwheels |
| 116 | Sun gearwheel | 118 | Carrier for the planet gearwheels |
| 200 | Summation gearbox | 201 | 1^{st} input of the summation gearbox |
| 202 | 2^{nd} input of the summation gearbox | 203 | 3^{rd} input of the summation gearbox |
| 210 | Planetary gearing | | |
| 212 | Ring gear | 214 | Set of planet gearwheels |
| 216 | Sun gearwheel | 218 | Carrier for the planet gearwheels |
| 300 | Summation gearbox | 301 | 1^{st} input of the summation gearbox |
| 302 | 2^{nd} input of the summation gearbox | 303 | 3^{rd} input of the summation gearbox |
| 310 | Planetary gearing | | |
| 312 | Ring gear | 314 | Set of planet gearwheels |
| 316 | Sun gearwheel | 318 | Carrier for the planet gearwheels |
| 400 | Electric machine | | |
| 405 | Externally excited direct current | 410 | Rotor |
| | machine | | |
| 415 | Commutation unit | 420 | Excitation coil |
| 430 | Electric power driving unit | 450 | Electric machine brake |
| 500 | Electric machine | | |
| 505 | Externally excited direct current | 510 | Rotor |
| | machine | | |
| 515 | Commutation unit | 520 | Excitation coil |
| 530 | Electric power driving unit | 550 | Electric machine brake |
| 600 | Electric machine | | |
| 605 | Externally excited direct current | 610 | Rotor |
| | machine | | |
| 615 | Commutation unit | 620 | Excitation coil |
| 630 | Electric power driving unit | 650 | Electric machine brake |
| 700 | Sub transmission | 701 | Input to sub transmission |
| 702 | Output of sub transmission | 704 | Countershaft |
| 710 | Input gearwheel for 1^{st} speed | 720 | Input gearwheel for 4^{th} speed |
| 722 | Unit to selectively connect input | | |
| | gearwheels to the countershaft. | | |
| 730 | Input gearwheel for 1^{st} reverse speed | 731 | Intermediate gearwheel |
| 732 | Unit to selectively connect input | | |
| | gearwheels to the countershaft. | | |
| 800 | Sub transmission | 801 | Input to sub transmission |
| 802 | Output of sub transmission | 804 | Countershaft |
| 810 | Input gearwheel for 2^{nd} speed | 820 | Input gearwheel for 5^{th} speed |
| 822 | Unit to selectively connect input | | |
| | gearwheels to the countershaft. | | |
| 830 | Input gearwheel for 2^{nd} reverse speed | 831 | Intermediate gearwheel |
| 832 | Unit to selectively connect input | | |
| | gearwheels to the countershaft. | | |
| 900 | Sub transmission | 901 | Input to sub transmission |
| 902 | Output of sub transmission | 904 | Countershaft |
| 910 | Input gearwheel for 2^{nd} speed | 920 | Input gearwheel for 5^{th} speed |
| 922 | Unit to selectively connect input | | |
| | gearwheels to the countershaft. | | |
| 930 | Input gearwheel for 2^{nd} reverse speed | 931 | Intermediate gearwheel |
| 932 | Unit to selectively connect input | | |
| | gearwheels to the countershaft. | | |

### DETAILED DESCRIPTION OF THE EXEMPLARY EMBODIMENTS

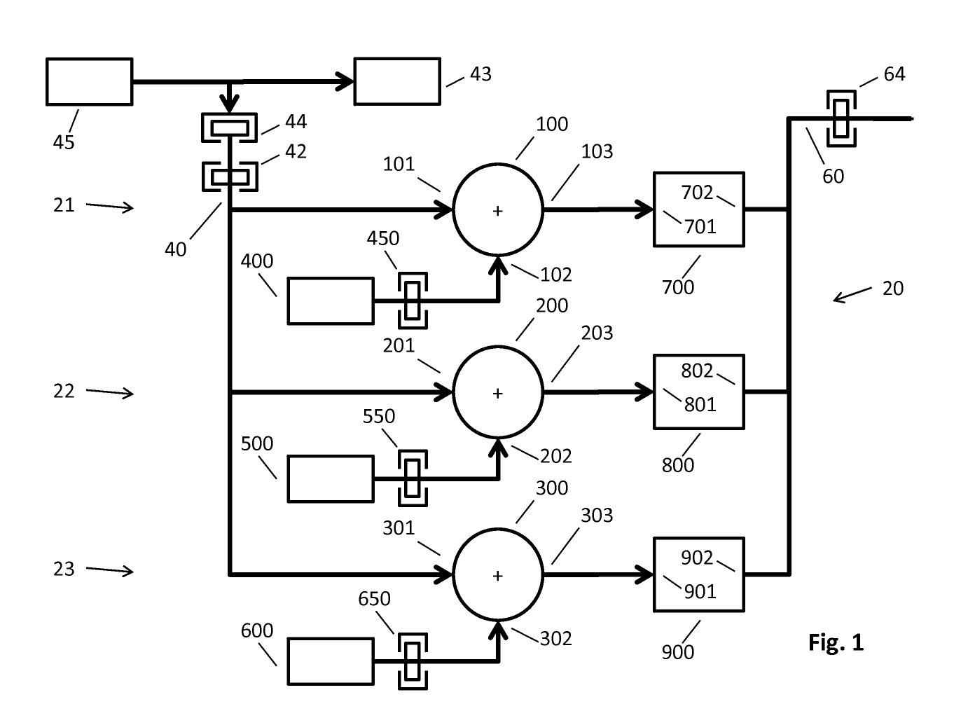

FIG. 1 shows an embodiment of a transmission (20) with an input shaft (40) which is connected to an output shaft (60) by means of three parallel power paths (21, 22, 23). Each of the parallel power paths (21, 22, 23) consists of a summation gearbox (100, 200, 300), an electric machine (400, 500, 600) capable of delivering and consuming mechanical rotation power and a sub transmission (700, 800, 900). Each of the sub transmissions (700, 800, 900) has one or more selectable or engage able gear ratios. One or more of the electric machines (400, 500, 600) may have an optional brake (450, 550, 650). The output shaft (60) may optionally have an output shaft break (64) which may also function as a parking brake. Optionally the said transmission (20) may be designed with more than three of said parallel power paths (21, 22, 23) with its corresponding components.

The input shaft (40) is driven by a mechanical rotational power source, internal combustion motor or a main motor (45) which can be connected directly to the input shaft (40) or optionally by means of a coupling device or a friction clutch (44). Optionally the input shaft (40) may also have an input shaft brake (42). Optionally the main motor may be connected to an additional electric machine (43) which may be used as a generator or as a motor.

The input shaft (40) is connected to the 1^{st} input (101, 201, 301) of each of said summation gearboxes (100, 200, 300). The 2^{nd} input (102, 202, 302) of each said summation gearbox (100, 200, 300) is connected to said electric machine (400, 500, 600). The 3^{rd} input (103, 203, 303) of each said summation gearbox (100, 200, 300) is connected to the input (701, 801, 901) of the corresponding sub transmission (700, 800, 900). The outputs (702, 802, 902) of all sub transmissions (700, 800, 900) are connected to the output shaft (60).

By this arrangement the total torque applied by the main motor (45) at the input shaft (40) can be distributed among the different power paths (21, 22, 23) and the additional electric machine (43). The amount of torque to each of the power paths (21, 22, 23) and to the additional electric machine (43) depends on the torque of each of the electric machines (400, 500, 600) and the torque of the additional electric machine (43).

The rotational speed at the output (103, 203, 303) of each of the summation gearboxes (100, 200, 300) is a function of the rotational speed at the input shaft (40) and the connected electric machine (400, 500, 600). This allows the rotational speed at the output (103, 203, 303) of each of the summation gearboxes (100, 200, 300) to be individually changed or modulated by the rotational speed of the electric machine (400, 500, 600). Individually modulating the speeds at each of the outputs (103, 203, 303) of the summation gearboxes allows to have different total gear ratios in each of the different power paths (21, 22, 23) engaged at the same time.

Combining the possibility of different total gear ratios in the different parallel power paths (21, 22, 23) to be engaged at the same time, with the possibility to individually control the distribution of the total torque at the input shaft (40) to each of the power paths (21, 22,23) allows to continuously vary the effective total gear ratio of the transmission (20).

While transferring torque from the input shaft (40) to the output shaft (60), some of the electric machines (400, 500, 600) will be generating electric power and some will be consuming electric power. The torque of each electric machine (400, 500, 600) can be controlled in such manner, that the sum of the generated electric power can be less, equal or greater than the consumed electric power depending on the desired operation. With that the transmission (20) can be used to generate electric power for loading a battery or for supplying power to other devices. Or the transmission (20) can increase or boost the mechanical power provided by the main motor (45) to the input shaft (40) making the transmission (20) deliver more mechanical power at the output shaft (60) while consuming electric power out of a battery or other power supply. This also allows delivering mechanical power at the output shaft (60) without any mechanical power at the input shaft (40).

This arrangement allows changing engaged gear ratios in the sub transmissions (700, 800, 900) without interrupting the transfer of torque from the input shaft (40) to the output shaft (60). For explaining the procedure for changing the engaged gear ratio, the power path (21, 22, 23) changing the engaged gear ratio will be called the shifting power path and the other power paths (21, 22, 23) will be denominated as the remaining power paths. For changing the gear ratio in the shifting power path, the electric machines (400, 500, 600) are controlled in such manner, that the torque transferred by the shifting power path is reduced to a value close to zero or to a value much lower than the remaining power paths. The total torque at the input shaft (40) will be distributed among the remaining power paths. Under this condition the used gear ratio in the sub transmission (700, 800, 900) of the shifting power path can be disengaged without significantly affecting torque transmission from the input shaft (40) to the output shaft (60). After disengaging the gear ratio, the electric machine (400, 500, 600) of the shifting power path can be controlled in such a manner to synchronize the new gear ratio to be engaged in the sub transmission (700, 800, 900). After synchronizing, the new gear ratio may be engaged and the shifting power path may restart to transfer a part of the total torque applied at the input shaft (40) to the output shaft (60).

Also other functions as starting the main motor (45) by using or the additional electric machine (43) and/or a combination of the electric machines (400, 500, 600), can be implemented.

In contrast to the embodiments described in U.S. Pat. No. 6,558,283 with only two parallel power paths (21, 22) the here described embodiments with three or more parallel power paths allows to control the torque in each power path (21, 22, 23) in such manner, that each of the power paths (21, 22, 23) transmits at maximum only a portion of the total torque applied at the input shaft (40), while maintaining the functionality of an infinitely variable transmission and allowing to implement functionalities for a hybrid vehicle. Reducing the maximum torque of each power path (21, 22, 23) to only a portion of the maximum torque of the transmission (20) allows designing every power path (21, 22, 23) for a lower maximum torque including the summation gearboxes (100, 200, 300), the electric motors (400, 500, 600) and the sub transmissions (700, 800, 900) allowing to reduce the costs for each of the power paths (21, 22, 23).

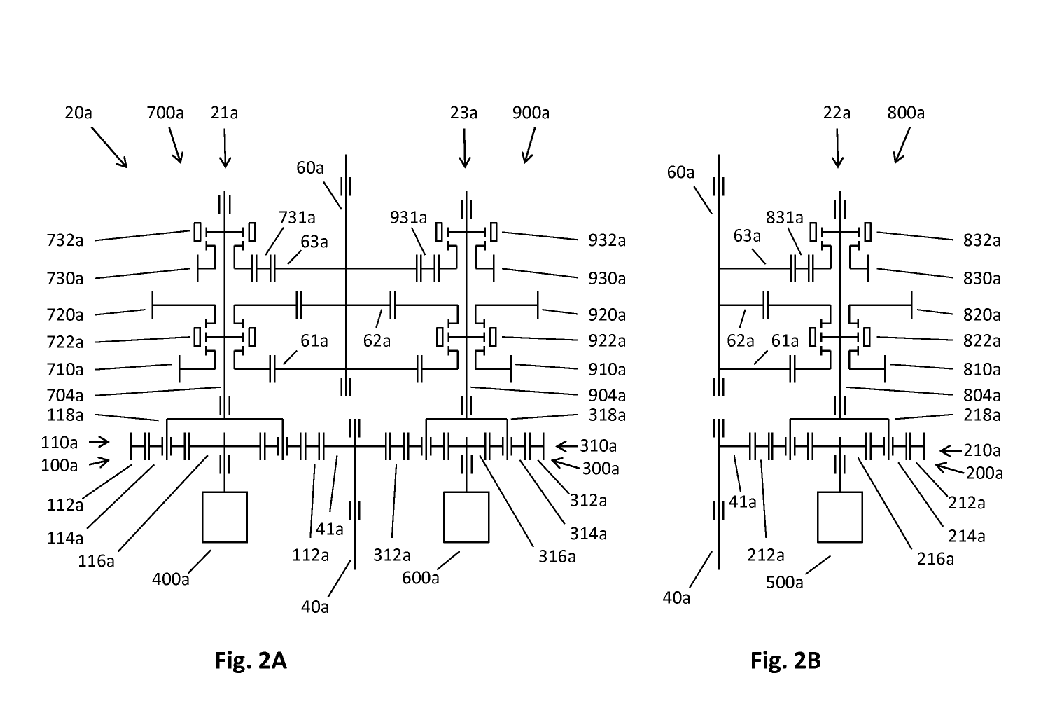

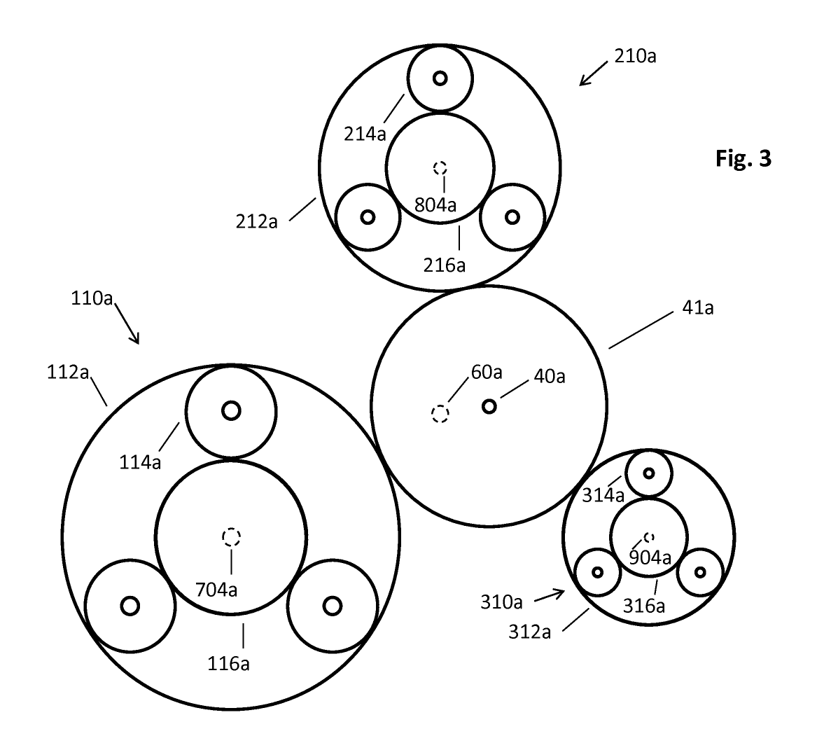

FIGS. 2A, 2B and 3 show schematically an embodiment of a transmission (20a) where the sub transmissions (700a, 800a, 900a) share the same output shaft (60a) and the countershafts (704a, 804a, 904a) of the different sub transmissions (700a, 800a, 900a) are arranged around the common output shaft (60a). FIG. 2A shows 2 of the 3parallel power paths referred in the text as being power paths A and C. FIG. 2B shows the 3^{rd} power path referred in the text as being power path B. FIG. 3 shows schematically the relative positions of input shaft, output shaft, countershafts, planetary gearboxes and a central gearwheel driving the ring gears of the planet gearboxes.

In the embodiment of FIG. 2A and 2B the summation gear boxes (100a, 200a, 300a) are implemented as planetary gearboxes (110a, 210a, 310a). Each planetary gearbox (110a, 210a, 310a) having a ring gear (112a, 212a, 312a) with teeth on the inside and teeth on the outside, a sun gear (116a, 216a, 316a) and a set of planet gears (114a, 214a, 314a). Each set of planet gears (114a, 214a, 314a) has a carrier (118a, 218a, 318a). The outer teeth of each ring gear (112a, 212a, 312a) do mesh with the teeth of a common gearwheel (41a) which is coupled to the input shaft (40a). By this arrangement the input shaft (40a) drives all three ring gears (112a, 212a, 312a) together. The sun gears (116a, 216a, 316a) of each planetary gearbox (110a, 210a, 310a) are coupled with the corresponding electric machine (400a, 500a, 600a). Each sub transmission (700a, 800a, 900a) has a countershaft (704a, 804a, 904a). Each countershaft (704a, 804a, 904a) carries its corresponding input gearwheels (710a, 810a, 910a, 720a, 820a, 920a) for the forward speeds and the input gearwheels (730a, 830a, 930a) for the reverse speeds. All the input gearwheels (710a, 810a, 910a, 720a, 820a, 920a, 730a, 830a, 930a) are disposed loosely on the corresponding countershafts (704a, 804a, 904a). By means of coupling devices (722a, 822a, 922a, 732a, 832a, 932a) the input gearwheels may be selectively fixed against rotation to the corresponding countershafts (704a, 804a, 904a). All sub transmissions (700a, 800a, 900a) share a common output shaft (60a) with its output gearwheels (61a, 62a, 63a). The teeth of input gearwheels (710a, 810a, 910a) do mesh with the teeth of the common output gearwheel (61a) and the teeth of the input gearwheels (720a, 820a, 920a) do mesh with the teeth of the common output gearwheel (62a). The teeth of the input gearwheels (730a, 830a, 930a) do mesh with the teeth of its corresponding intermediate gearwheel (731a, 831a, 931a) and the teeth of all intermediate gearwheels (731a, 831a, 931a) do mesh with the common output gearwheel (63a).

The gearwheels (710a, 810a, 910a) of the different sub transmissions (700a, 800a, 900a) meshing with the common gearwheel (61a) have all the same gear ratio. Also the gearwheels (720a, 820a, 920a) of the different sub transmissions (700a, 800a, 900a) meshing with the common gearwheel (62a) have all the same gear ratio. And also the gear ratios for the reversed speeds of all three sub transmissions (700a, 800a, 900a) employing the input gearwheels (730a, 830a, 930a) the intermediate gearwheels (731a, 831a, 931a) and the common output gearwheel (63a) are all the same. Each of the planetary gearboxes (110a, 210a, 310a) is designed to implement a different total gear ratio from the input shaft (40a) up to the carriers (118a, 218a, 318a). The combination of the different gear ratios of the different planetary gearboxes (110a, 210a, 310a) with the engage able gear ratios of their corresponding sub transmissions (700a, 800a, 900a) allows the different total gear ratios of each of the power paths (21a, 22a, 23a) to be all different among all the power paths. In a preferable embodiment power path A (21a) has the 1^{st} speed input gearwheel (710a), the 4^{th} speed input gearwheel (720a) and the 1^{st} reverse speed gearwheel (730a), while power path B (22a) has the 2^{nd} speed input gearwheel (810a), the 5^{th} speed input gearwheel (820a) and the 2^{nd} reverse speed input gearwheel (831a) and power path C (23a) has the 3^{rd} speed input gearwheel (910a), the 6^{th} speed input gearwheel (920a) and the 3^{rd} reverse speed input gearwheel (930a).

Using planetary gearboxes (110a, 210a, 310a) with different gear ratios to implement different total gear ratios among the different power paths (21a, 22a, 23a) allows to use similar countershafts (704a, 804a, 904a) with similar gearwheels (710a, 810a, 910a) for the 1^{st}, 2^{nd} and 3^{rd} speed, similar gearwheels (720a, 820a, 920a) for 4^{th}, 5^{th} and 6^{th} speed and similar gearwheels (730a, 830a, 930a) for 1^{st}, 2^{nd} and 3^{rd} reverse speed in all sub transmissions (700a, 800a, 900a). It also allows to arrange 3 different gear ratios or speeds in the same plane reducing the needed length of the countershafts (704a, 804a, 904a) and the output shaft (60a) for implementing the same total number of different speeds in the transmission.

FIG. 3 shows schematically the relative position of the input shaft (40a), the output shaft (60a), the countershafts (118a, 218a, 318a) of the different sub transmissions (700a, 800a, 900a) and the planetary gearboxes (110a, 210a, 310a) of the different power paths (21a, 22a, 23a) for the same embodiment as in FIG. 2.

The countershafts (704a, 804a, 904a) are arranged at a constant distance to the common output shaft (60a). The position of the input shaft (40a) relative to the output shaft (60a) and the diameter of the gearwheel (41a) driving all the ring gears (112a, 212a, 312a) depend on the different outer diameters of the ring gears (112a, 212a, 312a). The diameters of the sun gears (116a, 216a, 316a), the sets of planet gears (114a, 214a, 314a) and the inner and outer diameter of the ring gear (112a, 212a, 312a) are designed accordingly to implement the desired gear ratios between the gearwheel (41a) up to the carrier (118a, 218a, 318a) of each set of planet gears (114a, 214a, 314a) and the gear ratio of the sun gears (116a, 216a, 316a) up to the carrier (118a, 218a, 318a) of each set of planet gears (114a, 214a, 314a).

The embodiment of FIGS. 2A, 2B and 3 has several advantages as it allows reducing the physical size of the transmission (20a) compared to a transmission with the same number of speeds, same gear ratio range and same mechanical power. The reduction of size is due to a reduction of the sectional area and a reduction of the total length of the transmission. The sectional area gets reduced, as due to the reduced maximum torque of each power path the diameter of each gearwheel can be reduced. The reduced diameter has a greater impact on the sectional area than the increase of the sectional area caused by the additional countershafts.

Besides reducing the diameter of each gearwheel, also the width of each gearwheel may be reduced. The reduction of the width of each gearwheel together with the much higher number of different speeds in one plane of the transmission and no need for synchronizing rings results in shorter shafts. Also the bending forces on each shaft gets reduced as the torque of the countershafts gets reduced with the reduced maximum torque and as for the output shaft the different forces acting on the shaft do partially compensate each other, as the countershafts are arranged around the output shaft. The reduced forces and the reduced length of the shafts allows reducing the number of bearings needed for each shaft and this also helping to reduce the total length of the transmission.

The shown embodiment may also be implemented with more parallel power paths and with more different speeds.

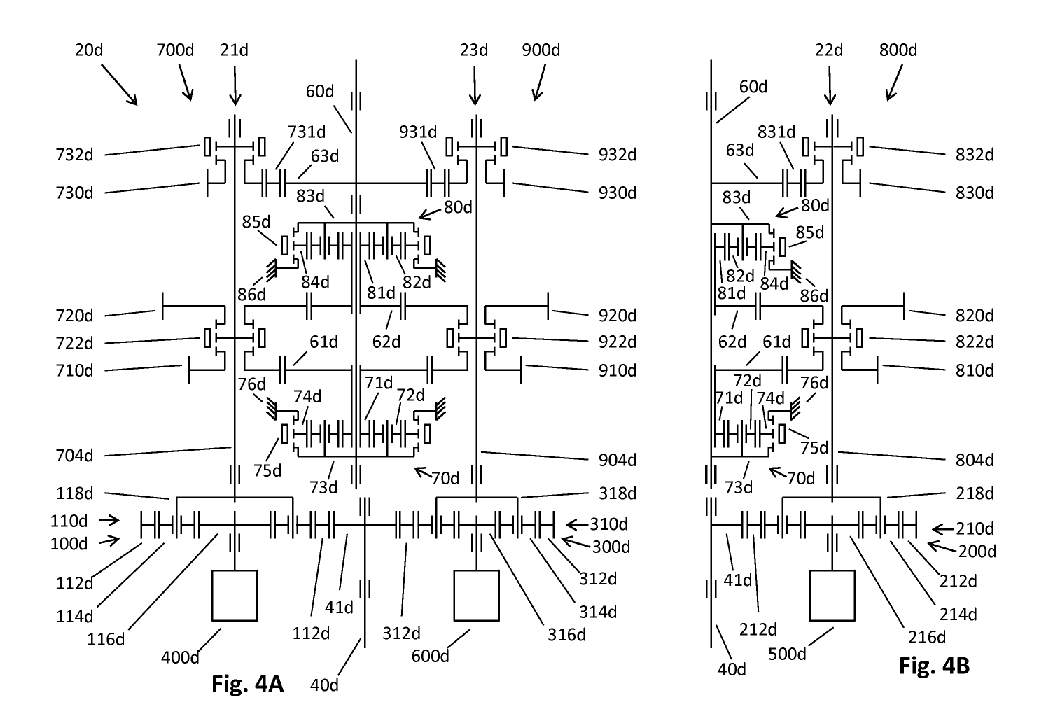

FIGS. 4A and 4B show schematically an embodiment with 3 parallel power paths and two range gearboxes resulting in a transmission with 12 forward speeds and 3 reverse speeds. FIG. 4A shows 2 of the 3 parallel power paths denominated in the text as power paths A and C. FIG. 4B shows the 3^{rd} parallel power path referred in the text as power path B.

In the embodiment of FIG. 4A and 4B the summation gear boxes (100d, 200d, 300d) are implemented as planetary gearboxes (110d, 210d, 310d). Each planetary gearbox (110d, 210d, 310d) having a ring gear (112d, 212d, 312d) with teeth on the inside and teeth on the outside, a sun gear (116d, 216d, 316d) and a set of planet gears (114d, 214d, 314d). Each set of planet gears (114d, 214d, 314d) has a carrier (118d, 218d, 318d). The outer teeth of each ring gear (112d, 212d, 312d) do mesh with the teeth of a common gearwheel (41d) which is coupled to the input shaft (40d). By this arrangement the input shaft (40d) drives all three ring gears (112d, 212d, 312d) together. The sun gears (116d, 216d, 316d) of each planetary gearbox (110d, 210d, 310d) are coupled with the corresponding electric machine (400d, 500d, 600d). Each sub transmission (700d, 800d, 900d) has a countershaft (704d, 804d, 904d). Each countershaft (704d, 804d, 904d) carries its corresponding input gearwheels (710d, 810d, 910d, 720d, 820d, 920d) for the forward speeds and the input gearwheels (730d, 830d, 930d) for the reverse speeds. All the input gearwheels (710d, 810d, 910d, 720d, 820d, 920d, 730d, 830d, 930d) are disposed loosely on the corresponding countershafts (704d, 804d, 904d). By means of coupling devices (722d, 822d, 922d, 732d, 832d, 932d) the input gearwheels (710d, 810d, 910d, 720d, 820d, 920d, 730d, 830d, 930d) may be selectively fixed against rotation to the countershafts (704d, 804d, 904d). All sub transmissions (700d, 800d, 900d) share a common output shaft (60d) with its output gearwheels (61d, 62d, 63d). The teeth of input gearwheels (710d, 810d, 910d) do mesh with the teeth of the common output gearwheel (61d) and the teeth of the input gearwheels (720d, 820d, 920d) do mesh with the teeth of the common output gearwheel (62d). The teeth of the input gearwheels (730d, 830d, 930d) do mesh with the teeth of its corresponding intermediate gearwheel (731d, 831d, 931d) and the teeth of all the intermediate gearwheels (731d, 831d, 931d) do mesh with the common output gearwheel (63d).

The gearwheels (710d, 810d, 910d) of the different sub transmission (700d, 800d, 900d) meshing with the common gearwheel (61d) have all the same gear ratio. Also the gearwheels (720d, 820d, 920d) of the different sub transmission (700d, 800d, 900d) meshing with the common gearwheel (62d) have all the same gear ratio. And also the gear ratios for the reversed speeds of all three sub transmissions (700d, 800d, 900d) employing the input gearwheels (730d, 830d, 930d) the intermediate gearwheels (731d, 831d, 931d) and the common output gearwheel (63d) are all the same. Each of the planetary gearboxes (110d, 210d, 310d) is designed to implement a different total gear ratio from the input shaft (40d) up to the carriers (118d, 218d, 318d). The combination of the different gear ratios of the different planetary gearboxes (110d, 210d, 310d) with the engage able gear ratios of their corresponding sub transmissions (700d, 800d, 900d) allows the different total gear ratios of each of the power paths (21d, 22d, 23d) to be all different among all the power paths.

For integrating the range gearboxes (70d, 80d) the output gearwheels (61d, 62d) on the output shaft (60d) are grouped together in a minimum of two groups of output gears. In the embodiment of FIG. 4A and 4B each output gearwheel (61d, 62d) forms its own group of output gears. The fixed coupling between the output gearwheels (61d, 62d) and the output shaft (60d) is replaced by a coupling allowing the output gearwheels (61d, 62d) to rotate on the output shaft (60d). For transferring torque from the output gearwheels (61d, 62d) to the output shaft (60d) an individual planetary gearbox (70d, 80d) for each output gearwheel (61d, 62d) is used. Each planetary gearbox (70d, 80d) consists of a sun gear (71d, 81d) rigidly coupled with the corresponding output gearwheel (61d, 62d), a set of planetary gears (72d, 82d) and their carrier (73d, 83d), a ring gear (74d, 84d) and a unit (75d, 85d) to selectively couple the ring gear (74d, 84d) with the carrier (73d, 83d) or with the transmission housing (76d, 86d). When the ring gear (74d) is coupled with the transmission housing (76d) the 1^{st}, 2^{nd} or 3^{rd} speed is available by engaging the input gears (710d, 810d, 910d) on the countershafts (704d, 804d, 904d). When the ring gear (74d) is coupled with the carrier (73d) then the input gearwheel (710d) becomes the 7^{th} speed, the input gearwheel (810d) becomes the 8^{th} speed and the input gearwheel (910d) becomes the 9^{th} speed. For the case of the ring gear (84d) being coupled with the transmission housing, the input gearwheels (720d, 820d, 920d) function as 4^{th}, 5^{th} and 6^{th} speed and when the ring gear (84d) is coupled with the carrier (83d) the input gearwheels (720d, 820d, 920d) function as 10^{th}, 11^{th} and 12^{th} speed respectively.

Changing the coupling of the ring gears (74d, 84d) of the range gearboxes may always occur without interrupting torque transmission to the output shaft (60d) when none of the power paths (21d, 22d, 23d) is applying torque to the corresponding range gearbox (70d, 80d). For example when the 4^{th}, 5^{th} and 6^{th} speeds are being used all torque is applied on the range gearbox (80d) and the coupling of the ring gear (74d) of the other range gearbox (70d) may be changed without load. Synchronization of the range gearboxes is done using conventional synchronizing mechanisms. The available time span for synchronizing the range gearboxes (70d, 80d) is generally much longer than compared with the time span in normal transmissions, as the total time while the transmission (20d) remains in the speeds without using the synchronizing range gearbox (70d, 80d) may be used for synchronization.

If only 9 forward speeds are desired the range gearbox (80d) can be replaced by a rigid coupling of the output gearwheel (62d) to the output shaft (60d).

The advantage of this embodiment compared to the standard application for range gearboxes with the output shaft of a main transmission being coupled to the input shaft of a range gearbox, is that shifting of the gears in the range gearboxes is possible without interrupting torque distribution to the output shaft of the transmission.

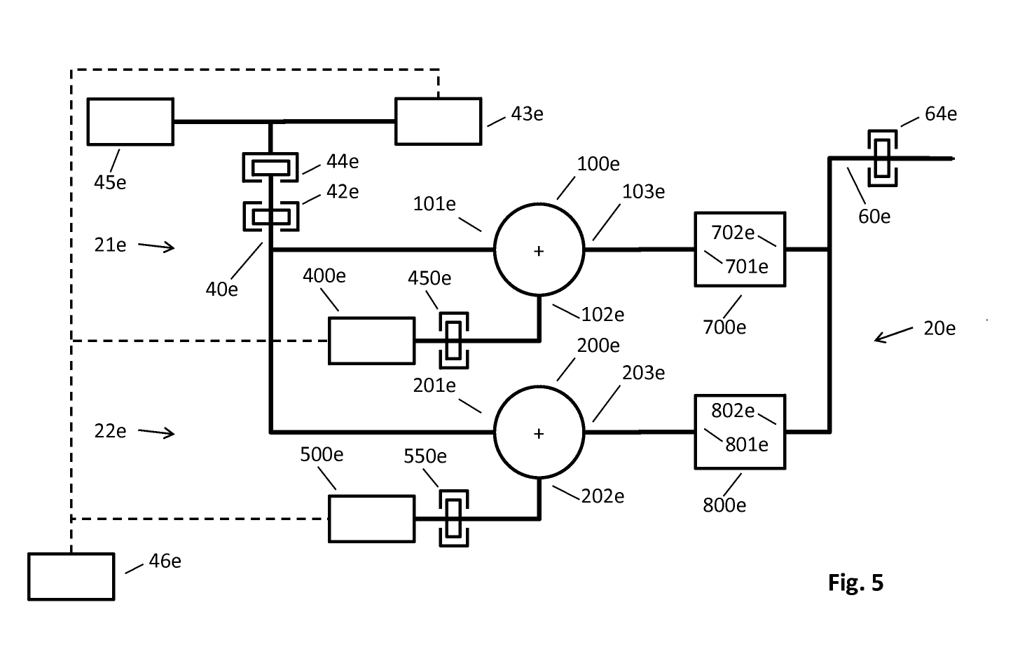

FIG. 5 shows an embodiment of a modulated shifting transmission (20e) with two power paths (21e, 22e) and including an additional electric machine (43e) coupled with a main motor (45e) and serving as an electric generator or as an electric motor. The main motor (45e) is coupled to the input shaft (40e) of the modulated shifting transmission (20e) by means of a clutch (44e) and a break (42e).

The additional electric machine (43e) together with the clutch (44e) and the brake (42e) allows decoupling the main motor (45e) from the input shaft (40e) and consequently mechanically isolates eventual torsional vibrations of the main motor (45e) from the rest of the power train. In case of the main motor (45e) being an internal combustion engine this engine generates torsional vibrations of significant amplitude specially while running at low speeds or while being started. While the main motor (45e) is decoupled from the input shaft (40e) of the transmission (20e), the transmission (20e) may still deliver mechanical rotational power at its output shaft (60e) by engaging the brake (42e) and employing the modulating electric machines powered with electric power generated by the additional electric machine (43e) or powered by another electric power supply or battery (46e). For applications in automotive vehicles this operation mode allows electric driving and starting the main motor (45e) as needed by using the additional electric machine (43e) and the battery (46e) as a power supply. As needed the main motor may be mechanically coupled or decoupled to the input shaft (40e) by engaging or disengaging the friction clutch (44e) and disengaging or engaging the brake (44e). The additional electric machine (43e) may also be used to start the main motor (45e).

The additional electric machine (43e) may also be used to reduce the maximum speed needed of the modulating electric machines (100e, 200e). This is done by disengaging single power paths (21e, 22e) when their torque contribution is only a small percentage of the total torque while the additional electric machine (43e) together with the remaining power paths and their modulating electric machines (100e, 200e) compensate the torque of the disengaged power path. For this purpose the additional electric machine (43e) or generates electric power and supplies it to the remaining power paths (21e, 22e) or consumes excessive electric power from the remaining power paths (21e, 22e). The time the single power path (21e, 22e) is disengaged can be used to synchronize the next gear ratio in its sub transmission (700e, 800e), allowing for longer synchronization times without affecting driving comfort in the case of an automotive vehicle application. Longer synchronization times reduce the need for very high deceleration and acceleration speeds of the modulating electric motors (100e, 200e).

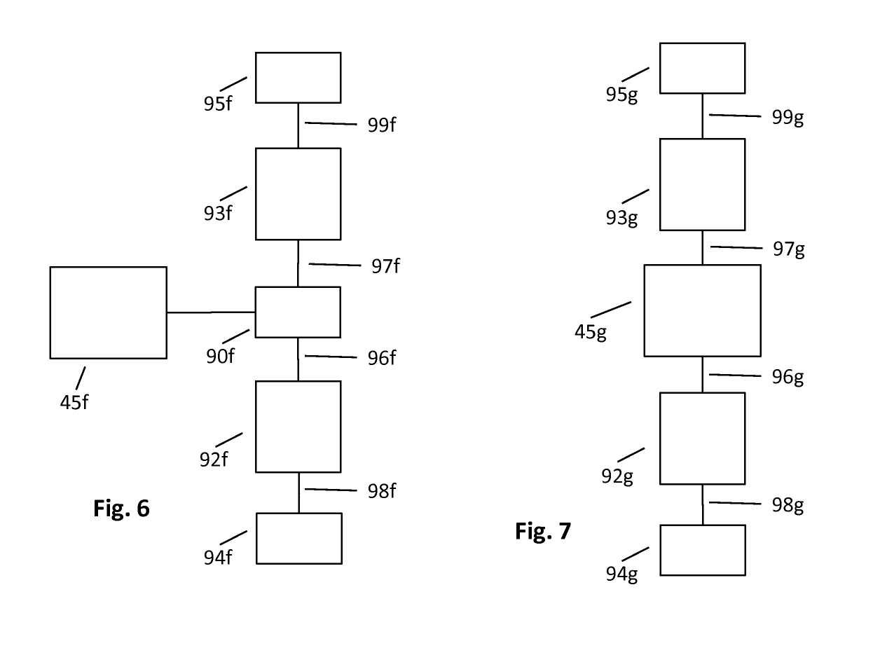

FIG. 6 shows an embodiment where one modulated shifting transmission is used for every driven wheel. Where the main motor (45f) is connected to gearing box or bevel bearing (90f) allowing for driving the input shafts (96f, 97f) of both modulated shifting transmissions (92f, 93f) in parallel. The output shaft (98f, 99f) of each modulated shifting transmissions (92f, 93f) drives its corresponding wheel (94f, 95f).

This embodiment allows replacing the normally used differential gearbox by a simple bevel bearing as the modulated shifting transmissions (92f, 93f) can compensate differences in speed of the wheels (94f, 95f) and allow implementing other functions like anti-skid control and to improve vehicle stability by actively controlling torque to each wheel (94f, 95f).

FIG. 7 shows an embodiment where the main motor (45g) has the possibility to connect an input shaft (96g, 97g) of modulated shifted transmissions (92g, 93g) at each end of the crank shaft of the internal combustion engine (45g). The main motor (45g) drives the input shaft (96g, 97g) of each modulated shifting transmission (92g, 93g) in parallel. The output shaft (98g, 99g) of each modulated shifting transmissions (92g, 93g) drive its corresponding wheel (94g, 95g).

This embodiment allows a very short power train from the main motor (45g) up to the wheels reducing weight, volume employed for the power train and reducing losses by friction. The modulated shifting transmissions (92f, 93f) compensate differences in speed of the wheels (94f, 95f) eliminating the need of a differential gearbox and allow implementing other functions like anti-skid control and to improve vehicle stability by actively controlling torque to each wheel (94f, 95f).

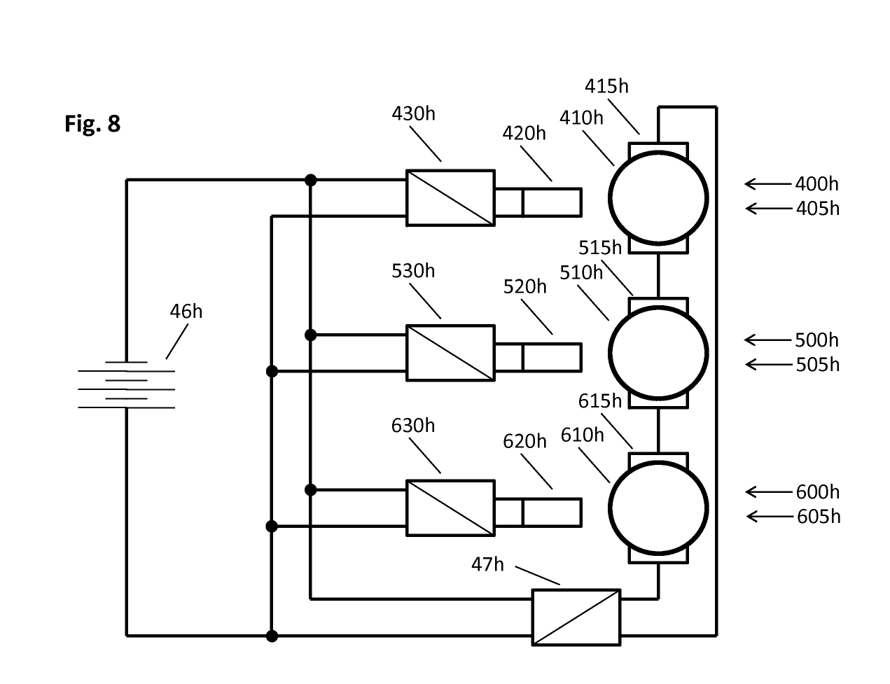

FIG. 8 shows schematically an embodiment where the electric machines (400h, 500h, 600h) are implemented using externally excited direct current machines (405h, 505h, 605h) reducing the required complexity and costs of the power electronics to control and drive the electric motors (400h, 500h, 600h).

In this embodiment the commutation units (415h, 515h, 615h) of the rotors (410h, 510h, 610h) of each externally excited direct current machine (405h, 505h, 605h) are connected in series to each other and connected in series with an optional power exchanging electronic unit (47h). Each externally excited direct current machine (405h, 505h, 605h) is controlled by driving its excitation coil (420h, 520h, 620h) by using electric power driving units (430h, 530h, 630h). Electric power for driving the excitation coils is provided by an additional power supply, a generator or a battery (46h). The power exchanging electronic unit (47h) allows to use excessive generated electric power to charge the battery (46h) or to use electric power out of the battery (46h) to boost power at the output shaft (60) of the transmission (20). This allowing to reduce the power electronics to only power the excitation coils (430h, 530h, 630h) and said power exchanging electronic unit (47h).

1. A transmission with an input shaft coupled by means of three or more parallel power paths to an output shaft, with each of said parallel power paths having a summation gearbox, an electric machine or a electric machine and a sub transmission with one or more selectable gear ratios, arranged in such manner, that controlling rotational speed and torque of each of said electric machines allows to control rotational speed and torque at the input of each of said sub transmissions individually and by that allowing to always distribute the total torque at said input shaft to at least two or more of said sub transmissions which together drive said output shaft of said transmission.

2. A transmission as defined in claim 1, where the different said selectable gear ratios of said sub transmissions result in individually different total gear ratios from said input shaft to said output shaft of the different said power paths.

3. A transmission as defined in claim 2, where some or all of said selectable gear ratios are similar among different said sub transmissions and different said total gear ratios between different power paths of said power paths are archived by having different gear ratios in said summation gearboxes.

4. A transmission as defined in claim 2, where the different said total gear ratios with same sign are distributed among the different said power paths in such manner, that when sorted by their total gear ratio values consecutive said total gear ratios are members of different said power paths.

5. A transmission as defined in claim 1, allowing to control said electric machines in each of said power paths in such a manner, that for changing the selected gear ratio in any of said sub transmissions the torque transmitted by the power path containing that sub transmission may be reduced to a level allowing to disengage the engaged gear ratio while the total torque transmitted by said transmission continues being transferred to said output shaft of said transmission by the remaining power paths of said power paths.

6. A transmission as defined in claim 5 where said electric machines are controlled in such a manner, that said electric machines do synchronize the next gear ratios to be engaged in said sub transmissions.

7. A transmission as defined in claim 1 where said electric machines are implemented as externally excited direct current machines and the electric inputs to the rotors of each of said externally excited direct current machines are connected in series by each other and optionally connected in series with a power exchange circuit, allowing to reduce the requirements for the power electronics to only control the excitation of said externally excited direct current machines.

8. A transmission as defined in claim 1, where said summation gearboxes are implemented by planetary gearboxes, with each of said planetary gearboxes having a sun gear, a set of planet gears, a carrier coupled to said set of planet gears and a ring gear, where said sun gear of each of said planetary gearboxes is coupled to one of said electric machines and said carrier of each of said planetary gearboxes is coupled to a countershaft and said countershafts are arranged around a common output shaft of said transmission and said ring gear of each of said planetary gearboxes has inside teeth and outside teeth, while said inside teeth do mesh with said set of planet gears and said outside teeth of said ring gear of all of said planetary gearboxes do mesh with the teeth of a common gearwheel driven by said input shaft of said transmission.

9. A transmission as defined in claim 8, where said common output shaft has one or more output gearwheels, where each of said output gearwheels does mesh directly or does mesh indirectly, by means of intermediate gearwheels, with a set of input gearwheels and each of said sets of input gearwheels consisting of one or more said input gearwheels and each of said input gearwheels of the same said set of input gearwheels being disposed on a different said countershaft.

10. A transmission as defined in claim 9, where said input gearwheels are disposed loosely on said countershafts in such a manner, that said input gearwheels may rotate in relation to said countershafts and individually for every said countershaft single said input gearwheels may be rigidly coupled to said countershaft by means of one or more selection units.

11. A transmission as defined in claim 9, where the different input gearwheels of said input gearwheels meshing with the same output gearwheel of said output gearwheels are disposed in one plane.

12. A transmission as defined in claim 9, where one or more of said countershafts are designed similar to each other and one or all of said planetary gearboxes are designed to implement different gear ratios between said input shaft of said transmission and said carriers coupled to said set of planet gears in such a manner, that the total gear ratios from said input shaft to said output shaft of the different said power paths become different between each other.

13. A transmission as defined in claim 9, with at least two of said output gearwheels, where one or more of said output gearwheels on said output shaft are loosely disposed on said output shaft, allowing them to rotate on said output shaft and said output gearwheels are coupled independently or in groups of output gearwheels by means of range gearboxes to said output shaft and said range gearboxes allow engaging different gear ratios between said output gearwheel or said group of output gearwheels and said output shaft.

14. A motorized vehicle with a transmission as defined in claim 1, where an internal combustion engine drives an additional electric machine which may function as an electric motor and/or as an electric generator.

15. A motorized vehicle as defined in claim 14, where said input shaft is coupled to said internal combustion engine by means of a friction clutch and an optional damper.

16. A motorized vehicle as defined in claim 14, with said input shaft having an engage able break.

17. A motorized vehicle having an internal combustion engine and using a dedicated transmission as defined in claim 1 to drive some or all of the wheels independently.

18. A motorized vehicle as defined in claim 17, where the internal combustion engine allows coupling one transmission to each end of the crank shaft allowing driving two sets of drive wheels independently.

19. A motorized vehicle as defined in claim 18 where the coupling between each of said ends of said crankshaft and each of said transmissions in done by means of a damper and/or a friction clutch.
